(19) United States
(12) Patent Application Publication
(10) Pub. No.: US 2013/0149228 A1
(43) Pub. Date: Jun. 13, 2013

(54) METHOD, SYSTEM AND APPARATUS FOR CONTROLLING PARTICLE SIZE IN A FLUIDIZED BED REACTOR

(71) Applicants: Maria Tomas Martinez, Murcia (ES); Manuel Vicente Vales Canle, Valencia (ES)

(72) Inventors: Maria Tomas Martinez, Murcia (ES); Manuel Vicente Vales Canle, Valencia (ES)

(73) Assignee: Siliken Chemicals, S.L., Casa Ibanez (ES)

(21) Appl. No.: 13/316,191

(22) Filed: Dec. 9, 2011

(51) Int. Cl. C01B 33/029; B01J 8/24

(52) U.S. Cl. 423/349; 422/145; 422/139

(57) ABSTRACT

A method, system, and apparatus for controlling the average particle size and the particle size distribution during a fluidized bed process in a fluidized bed reactor. More particularly, this disclosure relates to a method, system, and apparatus for controlling the average silicon particle size and the silicon particle size distribution during the production of high purity silicon.

### TECHNICAL FIELD

The present disclosure relates to a method, system, and apparatus for controlling the average particle size and the particle size distribution (PSD) during a fluidized bed process in a fluidized bed reactor (FBR). More particularly, this disclosure relates to a method, system, and apparatus for controlling the average silicon particle size and the silicon PSD in a FBR during the production of high purity silicon.

### BRIEF DESCRIPTION OF THE DRAWINGS

FIG. 1 shows one embodiment of a fluidized bed reactor (FBR).

FIG. 2 shows a detailed cross-sectional view of one embodiment of a gas injection zone of a FBR.

### DETAILED DESCRIPTION

Polycrystalline silicon may be used in the production of electronic components and solar panel construction. One conventional method of producing polycrystalline silicon is the traditional Siemens method and involves feeding a mixture comprising a silicon-bearing gas, such as hydrogen and silane (SiH₄), or a mixture comprising hydrogen and a halosilane, such as trichlorosilane (HSiCl₃), into a decomposition reactor. The gases are mixed inside the reactor and then decomposed onto the surface of a heated silicon filament or rod. The Siemens method requires a high amount of energy per unit of mass of produced silicon and has low productivity because of the limited surface area of the silicon filament or rod. Furthermore, the Siemens method is an inefficient batch process and the silicon rods produced by this method need further processing into smaller chunks or beads before they can be used.

Another method used for the production of silicon includes a fluidized bed process within a FBR. During silicon production according to a fluidized bed process, a gas mixture comprising hydrogen and a silicon-bearing gas, such as silane or trichlorosilane, may be added to a FBR having a fluidized bed of heated silicon particle seeds. The decomposition of silane or trichlorosilane causes the deposition of elemental silicon onto the surface of the heated silicon particles seeds which then grow in size within the reaction chamber of the FBR. When the silicon particles are large enough, they are passed out of the FBR in a continuous process as a high-purity silicon product. In comparison to the Siemens method, silicon production with a fluidized bed process is more efficient because it allows for a larger contact area between the silicon particles and the silicon-bearing gases, thereby enhancing the rate of thermal decomposition of the silicon-bearing gases on the surface of the silicon particles. Furthermore, a fluidized bed process dramatically reduces energy consumption during silicon production, utilizing approximately 10-15 kWh/kg of polysilicon, compared to the use of approximately 60-80 kWh/kg of polysilicon during the Siemens method.

Along with temperature, pressure, and reactant concentrations, controlling the average silicon particle size and the silicon PSD within the fluidized bed may be used to provide steady-state operational conditions in the FBR and promote the continuous production of high purity silicon. As used herein the term “particle size distribution” or PSD, refers to the number of silicon particles of certain sizes or in a range of sizes within a FBR. In certain embodiments, the way PSD is expressed or calculated can be defined by the method by which it is measured. For example, PSD may be calculated using a sieve analysis, where silicon particles may be separated using various sieves with different mesh or pore sizes. Thus, the PSD may be defined as a set of values providing the relative percentage of silicon particles that have a size that falls between the discrete size ranges: e.g. “% of sample between X μm and Y μm”. The PSD is usually determined over a determined set of size ranges that covers nearly all the sizes present in the sample.

The PSD is influenced by various factors both external and internal to the FBR. The external factors that control the PSD include the silicon seed feed rate, which is the rate at which silicon particle seeds are fed into the FBR, and the product removal rate, which is the total sum of the silicon product that is withdrawn from the FBR reactor. The internal factors controlling the PSD include the growth of silicon particles due to silicon deposition, the aggregation of silicon particles, and attrition or grinding of the silicon particles in the fluidized bed.

The growth of silicon particles by decomposition of a silicon-bearing gas may occur by way of chemical vapor deposition (CVD) and pyrolysis. Traditional models of CVD show that silicon deposition takes place on the surface of the silicon particles while they are located in the emulsion phase of the fluidized bed. CVD takes place across a boundary layer surrounding the fluidized silicon particles where silicon-bearing gases come in contact with the surface of the silicon particles. The flow of the silicon-bearing gas at the boundary layer is believed to be laminar, thereby enhancing the diffusion of the silicon-bearing gas across the boundary layer and allowing the deposition of silicon on the surface of the fluidized silicon particles.

The growth of the silicon particles may also happen via pyrolysis of the silicon-bearing gas and a scavenging effect in the fluidized bed. During gas-pyrolysis, new solid silicon deposition nuclei are generated which coalesce until they form small silicon particles. A scavenging effect in the fluidized bed may cause these small silicon particles to be incorporated into the silicon particle seeds, causing the silicon particles to grow.

The attrition of silicon particles by the grinding effect is another internal factor of a fluidized bed process that affects the PSD. The grinding effect is caused by the collision of silicon particles with each other and with the reactor wall and is dependent on the FBR operating conditions. More specifically, the fluid-dynamic and mechanical conditions that contribute to the grinding effect can include the gas jet properties, physical properties of the silicon particles (i.e., shape and surface roughness), operating temperature and pressure of the fluidized bed, residence time of the silicon particles in the FBR, the fluidization conditions measured in relation to minimum fluidization velocity, and the kinetic energy of the fluidizing gases.

### A Fluidized Bed Reactor for the Control of Particle Size Distribution

A FBR for the control of PSD during a fluidized bed process for the production of high-purity silicon is disclosed herein. In certain embodiments, the FBR disclosed herein comprises a reaction chamber having a bed of silicon particles that can be used as silicon particle seeds for a silicon decomposition reaction during which silicon is deposited on the surface of the silicon particles. In certain such embodiments, the silicon particles may be fluidized in the reaction chamber by injecting silicon-bearing gases and/or fluidizing gases into the reaction chamber. The silicon-bearing gases and the fluidizing gases may be injected into the reactor through a gas injection zone.

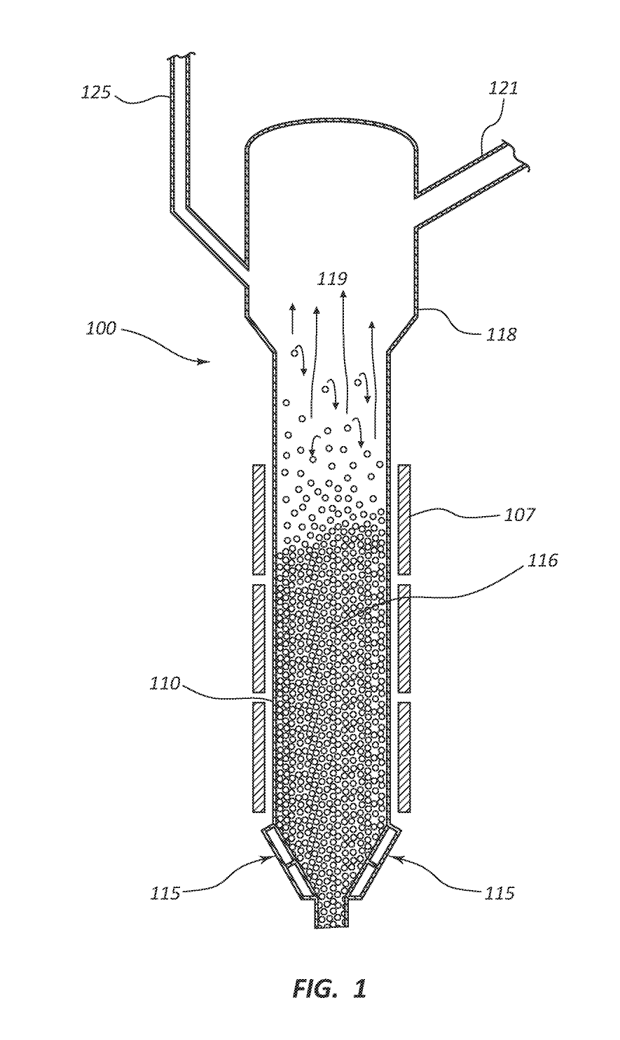

As shown in FIG. 1, the FBR 100 may include a reaction chamber 110 comprising a gas injection zone 115 and an expansion zone 118. The gas injection zone 115 may be located below the lower area of the reaction chamber 110 and designed to inject a silicon-bearing gas and/or a fluidizing gas towards the reaction chamber 110 and the silicon particles 116 located therein. In one embodiment, the expansion zone 118 may be located above the upper area of the reaction chamber 110 and comprise an area where the diameter of the FBR 100 increases and allows an expansion of the gases therein. In another embodiment, the reaction chamber 110 may be in contact with, adjacent to, or surrounded by a heating system, such as heating elements 107, for controlling the reaction conditions within the reaction chamber 110. In certain embodiments, the expansion of the fluidizing gases 119 in the expansion zone 118 decreases the velocity of the fluidizing gases 119, preventing the fluidized silicon particles from achieving entrainment velocity.

In one embodiment, the FBR 100 as shown in FIG. 1 may comprise one or more inlet ports and one or more outlet ports for introducing or removing gases and silicon particles from the reactor. In one such embodiment, the FBR 100 may comprise a silicon particle feed inlet 125 located in the expansion zone 118 and below the gas exit port 121. The reaction chamber 110 may be seeded with silicon particles 116 introduced through the silicon particle feed inlet 125 during initial startup of the FBR 100 and as the silicon particles 116 move through the reaction chamber 110 during the fluidized bed process. In another embodiment, the FBR 100 may comprise one or more gas outlets such as a gas outlet port 121 from which the fluidizing gases, silicon bearing gases, and other effluent gases may exit the reaction chamber 110.

In certain embodiments of a FBR as disclosed herein, a silicon-bearing gas and/or a fluidizing gas may be injected into a reaction chamber from a gas injection zone comprising a gas distribution plate. The gas distribution plate may include one or more chambers configured to deliver the silicon-bearing gas and/or the fluidizing gas into the reaction chamber. In particular embodiments, the distribution plate may be divided into at least two separate injection chambers. In one such embodiment, the at least two separate chambers each comprise one or more gas outlets, nozzles, or orifices through which the silicon-bearing gas or the fluidizing gas are injected into the reaction chamber. The gas outlets, nozzles, or orifices through which the gases are injected from each of the two separate injection chambers may be positioned uniformly or randomly in the gas distribution plate to provide a uniform injection of the gases from each of the injection chambers into the FBR. In particular embodiments, the at least two injection chambers may be configured to inject a mixture of a silicon-bearing gas and a fluidizing gas. In another such embodiment, the at least two injection chamber are configured to inject a silicon-bearing gas or a fluidizing gas, wherein the silicon-bearing gas and the fluidizing gas only mix together after being injected out of the gas distribution plate.

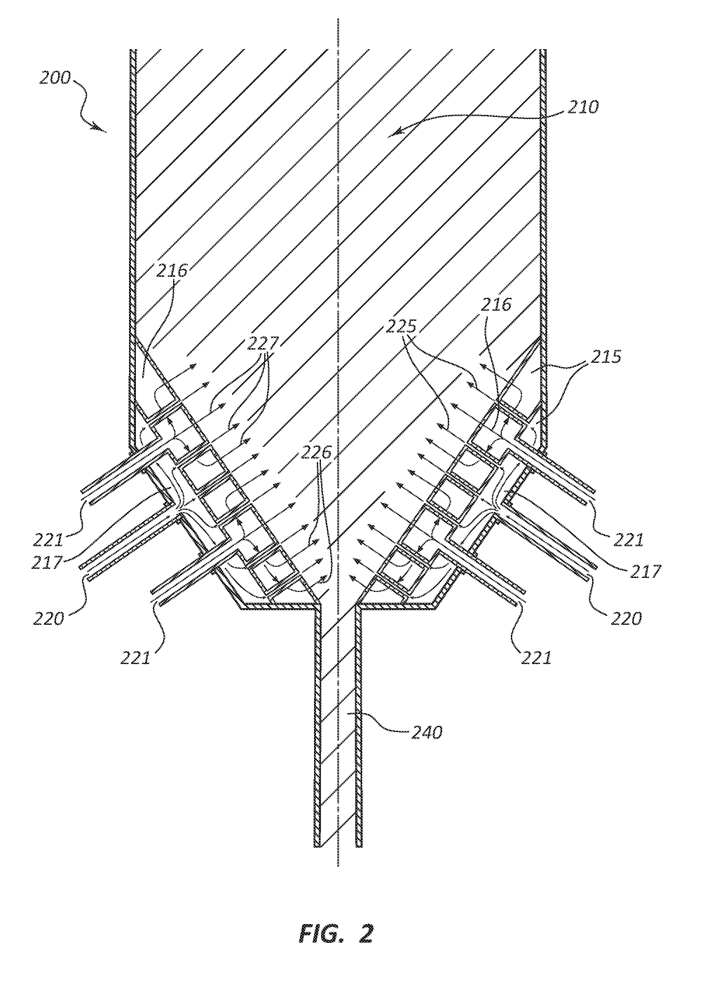

As shown by FIG. 2, one embodiment of a FBR 200 may comprise at least one gas injection zone for providing gas supply to the reaction chamber 210. In one such embodiment, the gas injection zone may include a gas distribution plate 215 designed to deliver one or more of a silicon-bearing gas and a fluidizing gas into the reaction chamber 210. In another such embodiment, the gas distribution plate 215 may be internally divided into two or more gas injection chambers. In particular embodiments, the gas distribution plate 215 may include a first injection chamber 216 and a second injection chamber 217. The first injection chamber 216 may be provided with one or more gases through one or more gas injection tubes, such as gas injection tube 221. The gases in the first injection chamber 216 may be injected into the reaction chamber 210 through one or more orifices 226. The second injection chamber 217 can be provided with one or more gases through one or more gas injection tubes, such as gas injection tube 220. The gases in the second injection chamber 217 can be injected into the reaction chamber 210 through one or more orifices 225. In one such embodiment, the first injection chamber 216 and the second injection chamber 217 may be provided with mixtures of one or more fluidizing and/or silicon-bearing gases.

With further reference to FIG. 2, a FBR as disclosed herein can include a gas distribution plate 215 with a relative position and inclination angle that may avoid stagnation of the fluidized allow the injected jets of gas 227 to avoid directly impacting the heated surfaces or walls of the reaction chamber 210, thereby avoiding undesired silicon deposition near the gas injection area. In particular embodiments, the gas distribution plate 215 may have an inclination angle (understood herein as the angle between the horizontal axis of the FBR and the angle of the distribution plate 215) ranging from approximately 65° to 75°. In one embodiment, the gas distribution plate 215 is designed to produce jets of gas 227 allowing the fluidizing gases to be injected in a bubbling phase before mixing with the silicon-bearing gas.

The gases and silicon particles used within a FBR as disclosed herein may be heated during the production of high purity silicon to temperatures ranging from approximately 500° C. to approximately 1200° C. For example, certain areas of the silicon deposition reactor 100 shown in FIG. 1 may be heated by the heating element 107 such that the silicon particles 116 and the silicon-bearing gases and the fluidizing gases within the reaction chamber 110 are heated to a temperature ranging from approximately 600° C. to 1100° C., or from 700° C. to 1000° C., or from 700° C. to 900° C., or from 750° C. to 850° C., or from 800° C. to 1000° C. In one embodiment, the temperatures in the reaction chamber 110 may be maintained at approximately 750° C. to 1050° C., 850° C. to 1000° C., and 900° C. to 950° C.

In one embodiment of a FBR as disclosed herein, the temperature of the silicon-bearing gases can be below the silicon decomposition temperature in certain areas of the reactor to avoid undesired silicon deposition. In one particular embodiment, the temperature of the silicon-bearing gas may be at from approximately 250° C. to 350° C. as the gas passes through the gas distribution plate 215 and into the reaction chamber 210 (FIG. 2) in order to avoid the deposition of unwanted silicon, such as in the orifices. For example, the silicon-bearing gas may be at a temperature below approximately 250° C., 260° C., 270° C., 275° C., 280° C., 290° C., 300° C., 310° C., 320° C., 330° C., 340° C., and 350° C. in order to avoid the deposition of unwanted silicon.

### Methods of Controlling the Average Particle Size and the Particle Size Distribution During the Production of Silicon

Methods of controlling the average particle size and the PSD during the production of high-purity silicon are disclosed herein. In certain embodiments, the methods of controlling the average particle size and the PSD disclosed herein include methods of controlling the average silicon particle size and the silicon PSD during a fluidized bed process in a FBR. In some embodiments, the methods of controlling the average particle size and the PSD disclosed herein comprise conditions that increase the average size and narrow the PSD of silicon particles within a FBR by deposition of silicon on the surface of the silicon particles. In other embodiments, the methods of controlling the average particle size and the PSD disclosed herein comprise conditions that promote the decrease in average particle size and widening the PSD through attrition and grinding of silicon particles in a FBR to generate small silicon particles to act as new seeds for silicon deposition.

1. Methods for Increasing the Average Particle Size Through Promoting the Growth of Silicon Particles.

In particular embodiments of the methods of controlling the average particle size and the PSD as disclosed herein, a fluidized bed process may be used during operation conditions that can favor the production of high-purity silicon through the growth of silicon particles in a FBR, wherein the silicon particles grow in size because of the deposition of silicon on the surface of the silicon particles. The growth of the silicon particles may generally increase the average particle size. In such embodiments, a FBR is provided comprising a gas distribution plate that includes a first injection chamber and a second injection chamber, such as the first injection chamber 216 and the second injection chamber 217 as shown in FIG. 2. In certain such embodiments, the first injection chamber may be used during operation conditions that can favor the production of high-purity silicon through the growth of silicon particles in a FBR. For example, the first injection chamber may be used for the injection of a mixture of fluidizing and silicon-bearing gases, wherein the molar composition of injected gases and total gas flow through the first injection chamber and the second injection chamber may be regulated in order to enhance the deposition of silicon on the surface of the silicon particles. Furthermore, under these operation conditions, attrition and grinding of the silicon particles are minimized, leading to particle growth and an increase in average silicon particle diameter size. In other such embodiments, the first injection chamber may be used for the injection of a mixture of fluidizing and silicon-bearing gases while the second injection chamber may be used for the injection of a minimum purging flow of gases needed to keep the orifices of the second injection chamber free from silicon particles.

As used herein a “silicon-bearing gas” is a gas that includes silicon in the molecular formula of the gaseous species. A silicon-bearing gas may include gaseous species which thermally decompose to form polysilicon. A silicon-bearing gas which decomposes when heated may be selected from the group of monosilane, disilane, trisilane, trichlorosilane, dichlorosilane, monochlorosilane, tribromosilane, dibromosilane, monobromosilane, triiodosilane, diiodosilane, monoiodosilane, and mixtures thereof. A silicon-bearing gas may also include those molecules that do not typically decompose to form polysilicon, such as a silicon tetrahalide like silicon tetrachloride, silicon tetrabromide and silicon tetraiodide.

As used herein a “fluidizing gas” is a gas that may contribute to the fluidization of the silicon particles, but does not thermally decompose to form polysilicon. It should be understood that silicon-bearing gases may also contribute to the fluidization of the silicon particles in a FBR. Exemplary fluidizing gases may include hydrogen, helium, argon, trichlorosilane, silicon tetrachloride, silicon tetrabromide, and silicontetraiodide.

In certain embodiments of the methods disclosed herein, the first injection chamber may be used for the injection of a mixture of fluidizing and silicon-bearing gases wherein at least one of the silicon-bearing gases is a silicon trihalide. In particular embodiments, the silicon-bearing gas is trichlorosilane (SiHCl₃), or TCS. When sufficiently heated, TCS decomposes in a fluidized bed process to form silicon on the fluidized silicon particles according to the following reaction:

4SiHCl₃→Si+3SiCl₄+2H₂ (thermal decomposition)

The formation of the high-purity silicon on the surface of the silicon particles increases the diameter of the silicon particles.

In some embodiments, the methods disclosed herein for controlling the average particle size and the silicon PSD comprise the injection from the first injection chamber of a mixture of fluidizing gases and silicon-bearing gases including approximately 50% or greater of a silicon trihalide, expressed in a molar ratio relative to the total gas mixture injected from the first injection chamber. In one embodiment, a mixture of gases including approximately greater than 50%, 55%, 60%, 65%, 70%, 75%, 80%, 85%, 90%, or 95% of a silicon trihalide, expressed in a molar ratio relative to the total gas mixture, may be injected from the first injection chamber. In another embodiment, the injection from the first injection chamber of a mixture of fluidizing gases and silicon-bearing gases may include approximately 50% or greater of a silicon trihalide in combination with approximately 5% to 10% of a silicon tetrahalide, such as silicon tetrachloride (STC), expressed in a molar ratio relative to the total gas mixture injected from the first injection chamber.

In other embodiments, the methods for the control of the average particle size and the PSD during the production of high-purity silicon comprise the injection from the first injection chamber of a mixture of fluidizing gases and silicon-bearing gases including approximately 10% to 25% hydrogen, expressed in a molar ratio relative to the total gas mixture injected from the first injection chamber. In one embodiment, a mixture of gases including approximately 10% to 25%, 12% to 25%, 15% to 25%, 17% to 25%, 20% to 25%, and 22% to 25% of hydrogen, expressed in a molar ratio relative to the total gas mixture, may be injected from the first injection chamber.

In particular embodiments, the methods disclosed herein for the control of the average particle size and the PSD during production of high-purity silicon comprise the injection from the first injection chamber of a mixture of fluidizing gases and silicon-bearing gases including approximately 10% to 25% hydrogen in combination with approximately 70% to 90% of a silicon trihalide, expressed in a molar ratio relative to the total gas mixture injected from the first injection chamber. In one such particular embodiment, the injection from the first injection chamber of a mixture of fluidizing gases and silicon-bearing gases may include approximately 10% to 25% hydrogen in combination with approximately 70% to 90% of trichlorosilane, expressed in a molar ratio relative to the total gas mixture injected from the first injection chamber. In another such embodiment, the injection from the first injection chamber of a mixture of fluidizing gases and silicon-bearing gases can include approximately 10% to 25% hydrogen, in combination with approximately 70% to 90% of a silicon trihalide, and in further combination with approximately 5% to 10% of a silicon tetrahalide, expressed in a molar ratio relative to the total gas mixture injected from the first injection chamber.

In certain embodiments of the methods for the control of the average particle size and the PSD during production of high-purity silicon disclosed herein, a mixture of fluidizing and silicon-bearing gases may exit from the first injection chamber having a subsonic velocity ranging from between approximately 30 m/s to approximately 55 m/s. In one such embodiment, a mixture of fluidizing and silicon-bearing gases may exit from the first injection chamber having a velocity ranging from between approximately 35 m/s to approximately 45 m/s, and between approximately 35 m/s to approximately 40 m/s. In another such embodiment, a mixture of fluidizing and silicon-bearing gases may exit from the first injection chamber having a velocity of approximately 35 m/s to 40 m/s, 40 m/s to 45 m/s, 45 m/s to 50 m/s, and 50 m/s to 55 m/s.

In particular embodiments, the methods disclosed herein for controlling the average particle size and the PSD during the production of high-purity silicon comprise a fluidized bed process including the injection from the first injection chamber of a mixture of fluidizing gases and silicon-bearing gases with sufficient flow to provide a desired fluidization ratio in the FBR. As used herein, the fluidization ratio is defined as the relationship between the actual fluidization velocity (U) and the minimum fluidization velocity (U_{mf}). In certain embodiments of the methods disclosed herein, the mixture of gases exiting from the first injection chamber may provide a gas flow to the fluidized bed between approximately 2×U_{mf} to approximately 6×U_{mf}. In one such embodiment, the mixture of fluidizing and silicon-bearing gases may exit from the first injection chamber with sufficient flow to provide a fluidization ratio of approximately 2×U_{mf} to 4×U_{mf}, 2.5×U_{mf} to 5×U_{mf}, 3×U_{mf} to 5×U_{mf}, 3.5×U_{mf} to 5×U_{mf}, 4×U_{mf} to 5.5×U_{mf}, 4.5×U_{mf} to 6×U_{mf}, 5×U_{mf} to 6×U_{mf}, and 5.5×U_{mf} to 6×U_{mf}.

As used herein, the U_{mf} defines the limit between a fluidized and a not fluidized bed. When the U value is in a condition in which 0<U<U_{mf}, then particles may be totally or partially quiescent while the gases flow through the particle bed interstices. When U reaches the U_{mf} value, the silicon particles inside the bed may be supported or fluidized by the gas flow. In one embodiment, at this minimum fluidization point of (U=U_{mf}), the voidage of the bed may correspond to the loosest packing of a packed bed (not fluidized bed), and the pressure drop due to gas flow is the minimum necessary to support the total weight of the silicon particles inside the bed.

The minimum fluidization velocity (U_{mf}) may generally depend on, for example, gas properties (viscosity and density), and silicon particle properties (particle size, shape, and density). There can be a number of semi-empirical correlations used to determine the U_{mf} in a fluidized bed. In one such embodiment, the Wen&Yu correlation (1966) can be used to determine the U_{mf}:

$${U}_{mf} = \frac{{μ}_{g}}{{d}_{{p}_{50 \%}} \cdot {ρ}_{g}} \cdot ( \sqrt{{C}_{1}^{2} + {C}_{2} \cdot Ar} - {C}_{1} )$$

Where, C1 and C2 are constants that can be empirically adjusted. In one particular embodiment, values for C1 may be between 28 and 34, and for C2 between 0.04 and 0.07. The variable Ar is the Archimedes number which is defined by the following expression:

$$Ar = \frac{{d}_{p , 50 \%} \cdot {ρ}_{g} \cdot ( {ρ}_{g} - {ρ}_{g} ) \cdot g}{{μ}_{g}^{2}}$$

Wherein μ_{g}=gas mixture viscosity, ρ_{g}=gas density, ρₚ=silicon particle density (2330 Kg/m³), and d_{p, 50%}=particle diameter value (this value is calculated from the PSD in such a way that the 50% of the total mass of particles inside the fluid bed have a diameter equal or less).

For example, in one embodiment of a FBR having a diameter of 100 mm, filled with 30 kg of silicon particles having an average particle diameter (dp50%) of 600 microns (standard deviation of 100 microns), the reactor at 800° C. and using trichlorosilane and hydrogen as silicon-bearing and fluidizing gases respectively, the U_{mf} can be estimated at around 0.09 m/s.

In certain embodiments of the methods disclosed herein for controlling the average particle size and the PSD during the production of high-purity silicon, the process of silicon deposition may be encouraged by maintaining an appropriate ratio between the total amount of reactive silicon-bearing gases (flow in kg/h) injected into the FBR and the total surface area of the silicon particles available for silicon deposition within the FBR. In particular embodiments of the disclosed herein, the average silicon particle diameter size in the FBR may be increased by adjusting the ratio of the flow of silicon-bearing gas to the total surface area of the silicon particles to be in a range from approximately 0.15 (kg/h gas/m² silicon particles) to approximately 0.75 (kg/h gas/m² silicon particles). In further embodiments, the silicon particle size diameter may be increased by adjusting the ratio of the flow of silicon-bearing gas to the total surface area of the silicon particles such that it is in a range from approximately 0.25 to approximately 0.6, approximately 0.3 to approximately 0.4, and approximately 0.3 to approximately 0.5. In still further embodiments, the silicon particle size diameter may be increased by adjusting the ratio of the flow of silicon-bearing gas to the total surface area of the silicon particles to be approximately at least 0.15, 0.2, 0.25, 0.3, 0.35, 0.4, 0.45, 0.5, 0.55, 0.6, 0.65, 0.7, and 0.75.

The total surface area of the silicon particles inside the FBR reactor may be estimated from the PSD and from the bed height. The PSD may be evaluated by sampling the silicon particles directly from the FBR. In one embodiment, the PSD may be determined by regularly sampling the silicon particles from the FBR and then using a sieving analysis method with a wide range of sieve mesh sizes, for example, sized from 100 microns to 4000 microns in order to provide an accurate measure of the sizes of the silicon particles within the FBR.

In other embodiments of the methods disclosed herein for controlling the average particle size and the PSD during the production of high-purity silicon, the mixture of fluidizing gases and silicon-bearing gases in the first injection chamber and the second injection chamber may be maintained at a temperature that is below the decomposition temperature of the silicon-bearing gas to prevent undesired silicon deposition. In one such embodiment, the temperature of the gases in the first injection chamber and the second injection chamber may be maintained at a temperature ranging from approximately 250° C. to 350° C. In another such embodiment, when the silicon-bearing gases comprise one or more halosilanes, such as chlorosilanes, for example trichlorosilane, the temperature of the gases in the first injection chamber and the second injection chamber may be maintained at a temperature ranging from approximately 250° C. to 300° C., or less than 300° C.

In further embodiments, the methods disclosed herein comprise the injection from the first injection chamber of a mixture of fluidizing gases and silicon-bearing gases in order to increase the average silicon particle size and narrow the PSD, optionally, the injection from the second injection chamber of a minimum purging flow of gases needed to keep the orifices of the second injection chamber free from silicon particles. In such embodiments, the minimum purging flow from the second injection chamber can depend on the PSD in the FBR. In other such embodiments, the minimum purging flow from the second injection chamber may comprise a composition of gases that are regulated to ensure that the total molar concentrations of the gases are consistent with the gases injected by the first injection chamber. In one embodiment, the minimum purging gas flow from the second injection chamber may comprise at least 5% or at least 10% silicon tetrahalide diluted in hydrogen.

2. Methods for Decreasing Average Particle Size Through Promoting Attrition and Grinding of Silicon Particles.

In certain embodiments of the methods disclosed herein for controlling the average particle size and the PSD during the production of high-purity silicon, a FBR may be provided comprising a gas distribution plate that includes a first injection chamber and a second injection chamber, wherein the second injection chamber may be used during operation conditions that can decrease the average particle size and widen the PSD by promoting silicon particle attrition and grinding in the FBR.

In some embodiments, silicon particle attrition and grinding may be promoted by elevating kinetic energy levels alone in the FBR by increasing the velocities of the injected gases in order to cause more particle agitation and impacts between the silicon particles themselves and between the silicon particles and the reactor. However, in such embodiments, the gas velocities needed to create the elevated kinetic energy levels sufficient for silicon particle attrition may be outside of the desired operating conditions of the FBR and could require the use of special gas injection nozzles and reactor equipment. In alternative embodiments, such as the methods of controlling the particle size described herein, the chemical composition of the injected gases may be adjusted to allow attrition of the silicon particles while avoiding high gas velocities and kinetic energy levels that are outside the desired operating conditions of the FBR and that may require special gas injection nozzles and other equipment.

In other embodiments of the methods for controlling particle size disclosed herein, silicon particle attrition may be promoted and controlled by modifying the mechanical properties of the silicon particles. For example, the mechanical properties of the silicon particle structure and surface may be changed by adjusting the composition and molar ratios of the silicon-bearing gases inside the FBR as disclosed herein. The mechanical properties of the silicon particles that may be modified include those properties that result from the chemistry of the silicon deposition reaction or the process of silicon deposition. In some embodiments, the mechanical properties of the silicon particles that may be modified by adjusting the composition of the injected gases include the structure of the silicon particles such as the formation of three-dimensional islands, whiskers, platelets, coiled fibers, and nano-tubes. In other embodiments, the mechanical properties of the silicon particles that may be modified by adjusting the composition of the injected gases include thickness uniformity, crystalline nature, deposition defects, localized residual stresses, and density distribution.

In certain embodiments of the methods disclosed herein for controlling the average particle size, the second injection chamber, such as the second injection chamber 217 as shown in FIG. 2, may be used for the injection of a mixture of fluidizing and silicon-bearing gases, wherein the molar composition of the injected gases and total gas flow through both the first injection chamber and the second injection chamber may be regulated to enhance the attrition and grinding effect of silicon particles in the FBR. In such embodiments, the second injection chamber may be used for the injection of a mixture of fluidizing and silicon-bearing gases while the first injection chamber may be used for the injection of a minimum purging flow of gases needed to keep the orifices of the first injection chamber free from silicon particles. In certain such embodiments, the PSD is widened as fines are generated. As used herein, the term “grinding” is understood as the generation of fine silicon particles, or fines, from larger silicon particles. The fines generated from the attrition and grinding of the silicon particles in the FBR may be used as new seeds for silicon deposition in a fluidized bed process. Because the fines are generated inside the FBR from a high-purity silicon source, the feeding of external silicon particle seeds can be minimized or eliminated.

In particular embodiments of the methods disclosed herein, the second injection chamber may be used for the injection of a mixture of fluidizing and silicon-bearing gases wherein the silicon-bearing gases comprise a combination of a silicon tetrahalide and a silicon trihalide. In certain particular embodiments, the second injection chamber may inject a mixture of silicon-bearing gas comprising silicon tetrachloride (SiCl₄), or STC, in combination with TCS.

In other embodiments of the methods of controlling the average particle size and the PSD as disclosed herein comprising the promotion of attrition and grinding of the silicon particles in the FBR, the first injection chamber may inject a minimum purging flow of gases needed to keep the orifices of the first injection chamber free from silicon particles. In such embodiments, the minimum purging flow from the first injection chamber can depend on the PSD in the FBR. In some such embodiments, the minimum purging flow from the first injection chamber may comprise a mixture of fluidizing and silicon-bearing gases that are regulated to ensure that the total molar concentrations of the gases are consistent with the gases injected by the second injection chamber. In one embodiment, the minimum purging flow from the first injection chamber may comprise approximately 10% silicon tetrachloride diluted with hydrogen.

In some embodiments, the methods for controlling the average particle size and the PSD during production of high-purity silicon comprise the injection from the second injection chamber of a mixture of fluidizing gases and silicon-bearing gases including approximately 60% or greater of a silicon tetrahalide gas, expressed in a molar ratio relative to the total gas mixture injected from the second injection chamber. In one embodiment, a mixture of gases including approximately greater than 50%, 55%, 60%, 65%, 70%, 75%, 80%, 85%, 90%, or 95% of a silicon tetrahalide, expressed in a molar ratio relative to the total gas mixture, may be injected from the second injection chamber.

In another embodiment of the methods disclosed herein for controlling the average particle size and the PSD during the production of high-purity silicon, the injection from the second injection chamber may comprise a mixture of fluidizing gases and silicon-bearing gases including approximately 60% or greater of a silicon tetrahalide gas and approximately 15% to 30% of a silicon trihalide gas, expressed in a molar ratio relative to the total gas mixture injected from the second injection chamber. In still another embodiment, a mixture of gases including approximately greater than 50%, 55%, 60%, 65%, 70%, 75%, 80%, 85%, and 90% of a silicon tetrahalide and approximately 15% to 30%, 20% to 30%, and 25% to 30% of a silicon trihalide, expressed in a molar ratio relative to the total gas mixture, may be injected from the second injection chamber.

In further embodiments, the methods disclosed herein for controlling the average particle size and the PSD during the production of high-purity silicon comprise the injection from the second injection chamber of a mixture of fluidizing gases and silicon-bearing gases including approximately 10% to 25% hydrogen, expressed in a molar ratio relative to the total gas mixture injected from the second injection chamber. In one embodiment, a mixture of gases including approximately 10%, 12%, 15%, 17%, 20%, 22%, 25% of hydrogen, expressed in a molar ratio relative to the total gas mixture, may be injected from the second injection chamber.

In further embodiments of the methods disclosed herein for controlling the average particle size and the PSD during the production of high-purity silicon, the injection from the second injection chamber may comprise a mixture of fluidizing gases and silicon-bearing gases including between 60% to 75% of a silicon tetrahalide gas and approximately 15% to 30% of a silicon trihalide gas, in further combination with approximately 10% to 25% hydrogen, expressed in a molar ratio relative to the total gas mixture injected from the second injection chamber.

In certain embodiments of the methods for controlling the average particle size and the PSD during the production of high-purity silicon disclosed herein, including the promotion of attrition and grinding of the silicon particles, a mixture of fluidizing and silicon-bearing gases may exit from the second injection chamber having a subsonic velocity ranging from between approximately 50 m/s to approximately 75 m/s. In one such embodiment, a mixture of fluidizing and silicon-bearing gases may exit from the second injection chamber having a velocity ranging from between approximately 55 m/s to approximately 70 m/s, and between approximately 60 m/s to approximately 70 m/s. In another such embodiment, a mixture of fluidizing and silicon-bearing gases may exit from the second injection chamber having a velocity of approximately 50 m/s to 60 m/s, 55 m/s to 65 m/s, 60 m/s to 65 m/s, 65 m/s to 79 m/s, and 70 m/s to 75 m/s.

In particular embodiments, the methods disclosed herein for controlling the average particle size and the PSD during the production of high-purity silicon comprise a fluidized bed process including the injection gas flow from the second injection chamber of a mixture of fluidizing gases and silicon-bearing gases, combined with the injection gas flow from the first injection chamber, the combination having a sufficient gas flow to provide a desired fluidization ratio in the FBR. In certain embodiments of the methods disclosed herein, the mixture of gases exiting from the first injection chamber and the second injection chamber may provide a gas flow to the fluidized bed between approximately 4×U_{mf} to approximately 8×U_{mf}. In one such embodiment, the mixture of fluidizing and silicon-bearing gases may exit from the first injection chamber and the second injection chamber with combined flow to provide a fluidization ratio of approximately at least 4×U_{mf}, 4.5×U_{mf}, 5×U_{mf}, 5.5×U_{mf}, 6×U_{mf}, 6.5×U_{mf}, 7×U_{mf}, 7.5×U_{mf}, and 8×U_{mf}.

In certain embodiments of the methods disclosed herein for controlling the average particle size and the PSD during the production of high-purity silicon, the attrition and grinding of the silicon particles in the FBR may be promoted by regulating the ratio between the total amount of reactive silicon-bearing gases (kg/h) injected into the FBR and the total surface area of the silicon particles available for silicon deposition within the FBR. By controlling the chemistry of the reaction conditions, the attrition and grinding of the silicon particles for the production of silicon seed particles may be promoted during normal particle agitation and without having to increase the fluidization or gas velocities above supersonic levels and without needing to use alternative nozzle or reactor designs such as those necessary in other methods promoting the grinding or attrition of silicon particles. In particular embodiments of the methods disclosed herein, the attrition and grinding of the silicon particles in the FBR may be increased by adjusting the ratio of the flow of silicon-bearing gas to the total surface area of the silicon particles to be in a range from approximately 0.05 (kg/h gas/m² silicon particles) to approximately 0.25 (kg/h gas/m² silicon particles). In further embodiments, the attrition and grinding of the silicon particles in the FBR may be increased by adjusting the ratio of the flow of silicon-bearing gas to the total surface area of the silicon particles such that it is in a range from approximately 0.1 (kg/h gas/m² silicon particles) to approximately 0.2 (kg/h gas/m² silicon particles), approximately 0.1 (kg/h gas/m² silicon particles) to approximately 0.15 (kg/h gas/m² silicon particles), and approximately 0.1 (kg/h gas/m² silicon particles) to approximately 0.25 (kg/h gas/m² silicon particles). In still further embodiments, the attrition and grinding of the silicon particles in the FBR may be increased by adjusting the ratio of the flow of silicon-bearing gas to the total surface area of the silicon particles to be approximately less than 0.05, 0.075, 0.1, 0.125, 0.15, 0.175, 0.2, 0.225 and 0.25 (kg/h gas/m² silicon particles).

Also disclosed herein is a system for controlling average silicon particle size and the PSD during the production of high-purity silicon using a fluidized bed process. In some embodiments, the system comprises a FBR with a reaction chamber designed to hold fluidized particles, the reaction chamber having a gas injection zone with a gas distribution plate that is divided into at least two injection chambers. In one such embodiment, at least two injection chambers are configured to deliver a silicon-bearing gas and/or a fluidizing gas into the reaction chamber. In another such embodiment, the at least two injection chambers are designed to prevent any mixing of the gases in the at least two separate injection chambers before being injected into the reaction chamber.

In another embodiment of the system for controlling the average silicon particle size and the PSD, the gas distribution plate comprises a first injection chamber in fluid communication with a gas source capable of providing a fluidizing gas and/or a silicon-bearing gas, and a second injection chamber in fluid communication with a gas source capable of providing a fluidizing gas and/or a silicon-bearing gas. In one such embodiment, the first injection chamber may inject a mixture of fluidizing and silicon-bearing gases that can promote the increase of silicon particle size in a FBR. In another such embodiment, the second injection chamber may inject a mixture of fluidizing and silicon-bearing gases that can promote the attrition and grinding of silicon particles into smaller silicon particles or fines.

In certain embodiments of the system disclosed herein for controlling the average silicon particle size and the PSD during the production of high-purity silicon, the first injection chamber may inject a mixture of fluidizing gases and silicon-bearing gases including between approximately 10% and 25% hydrogen, in combination with approximately 70% to 90% of a silicon trihalide, and in further combination with approximately 5% to 10% of a silicon tetrahalide, expressed in a molar ratio relative to the total gas mixture injected from the first injection chamber.

In other embodiments of the system disclosed herein for controlling the average silicon particle size and the PSD during the production of high-purity silicon, the second injection chamber may inject a mixture of fluidizing gases and silicon-bearing gases including between approximately 60% to 75% a silicon tetrahalide gas and between approximately 15% to 30% of a silicon trihalide gas, in further combination with between approximately 10% to 25% hydrogen, expressed in a molar ratio relative to the total gas mixture injected from the second injection chamber.

### EXAMPLES

The specific examples included herein are for illustrative purposes only and are not to be considered as limiting to this disclosure. The compositions referred to and used in the following examples are either commercially available or can be prepared according to standard literature procedures by those skilled in the art.

### Example 1

### Increasing the Average Silicon Particle Diameter Size

A system for controlling the average silicon particle size and PSD during the production of high-purity silicon was assembled including a FBR having a reaction chamber with a 200 mm inner diameter, and a height of 6 m. The reaction chamber was equipped at the top with an expansion zone (600 mm diameter, 2 m height). The expansion zone, towards the top, included a gas exit port to allow the exit of gases from the reaction chamber. The bottom part of the reactor included a conical, orifice-type distributor plate, divided in two different, non-interconnected injection chambers. The reactor was also equipped with a silicon product removal outlet located at the bottom of the conical distributor plate. This removal outlet was used for sampling of silicon particles and determining the PSD for purposes of estimating the total surface area of the silicon particles.

Temperature in the reactor was measured by means of two thermocouples, located at different positions in the reactor heated area, and in contact with the reactor external wall. The reactor was heated to an operating temperature of 920° C. Gases were preheated before they entered the reactor to a temperature of 290° C. Pressure changes in the reactor were measured and controlled in the removal outlet, and kept constant at a relative pressure of 650 mbar.

The reactor was filled with an initial charge of 120 kg of silicon particles. The PSD average diameter (dp50%) was 600 microns, with a maximum diameter (dp95%) of 1200 microns (maximum diameter was calculated as the value at the 95 percentile).

Gases were injected into the reactor through the first injector chamber and the second injector chamber of the distributor plate. Through the first injection chamber, a gas mixture (expressed as a molar ratio) including 25% hydrogen, 70% trichlorosilane and 5% silicon tetrachloride was injected into the reactor. The second injection chamber injected a minimum purging gas flow including a mixture of a minimum of 10% silicon tetrachloride diluted in hydrogen to avoid deposition at the orifices of the second injection chamber.

The reactor was operated for a total time of 150 hours. Every 4 hours during the test, a sample of silicon particles was removed from the reactor to measure variations in PSD, and also to estimate the total surface area of the silicon particles. The fluidization velocity in the reactor was maintained in a range between 4.5×U_{mf} to 6×U_{mf}. The gas exit velocity at the exit of the orifices of the first injection chamber was kept below 45 m/s. Total gas flow injected in the reactor was continuously regulated to maintain the fluidization velocity and the gas exit velocity.

After the test, the silicon product was removed from the reactor and the final PSD was measured. A quasi-linear growth of the average particle diameter size (dp50%) was observed (from 600 microns to 1650 microns). The dp95% value showed an increase from 1200 microns to 2200 microns. The relationship between dp50% and dp95% showed a narrower PSD at the end of the test in contrast with the initial one. Particles below 800 microns almost completely disappeared.

### Example 2

### Promoting Attrition and Grinding of the Silicon Particles

The system for controlling the average silicon particle size and PSD during the production of high-purity silicon, including the FBR, was assembled according to the system in Example 1.

The temperature in the reactor was measured by means of two thermocouples, located at different positions in the reactor heated area, and in contact with the reactor external wall. The reactor was heated to an operating temperature of 920° C. Gases were preheated before they entered the reactor to a temperature of 290° C. Pressure changes in the reactor were measured and controlled in the removal outlet, and kept constant at a relative pressure of 650 mbar.

The reactor was filled with an initial charge of 120 kg of silicon particles from the silicon product obtained from Example 1. The average silicon particle diameter size (dp50%) was 1650 microns, with a maximum diameter (dp95%) of 2200 microns.

Gases were injected into the reactor through the first injector chamber and the second injector chamber of the distributor plate. Through the first injection chamber a minimum purging gas flow was injected comprising a mixture of a minimum of 10% silicon tetrachloride diluted in hydrogen to avoid deposition at the orifices of the first injection chamber. From the second injection chamber a gas mixture (expressed as a molar ratio) including 15% hydrogen, 60% silicon tetrachloride, and 25% trichlorosilane was injected.

The reactor was operated for a total time of 20 hours. Every 1 hour during the test, a sample of silicon particles was removed from the reactor to measure variations in PSD, and also to estimate the total surface area of the silicon particles. The fluidization velocity in the reactor was maintained in a range between 5×U_{mf} to 7×U_{mf}. The gas exit velocity at the exit of the orifices of the first injection chamber was kept between 55 m/s and 65 m/s. Total gas flow injected in the reactor was continuously regulated to maintain the fluidization velocity and the gas exit velocity.

After the test, the silicon product was removed from reactor and the final PSD was measured. The average silicon particle diameter size (dp50%) decreased from 1650 microns to 950 microns. The dp95% value remained nearly constant from 2200 microns to 2050 microns. The decrease in dp50% was predominantly the result of a decline in the size of particles that were originally sized in the range from 1000 microns to 1400 microns, that were decreased to a size between 500 microns and 800 microns. The quantity of particles in the range below 500 microns was less than 5%. Particles over 2000 microns exceeded 15% of the total. The results showed the successful attrition and grinding of large silicon particles into smaller silicon particles.

### Example 3

### The Use of Inert Fluidization Gases

In order to check the effects of the molar composition of reactants on the mechanical properties of silicon particles, a reference test divided in two different replicas was conducted. The target of this test was to remove the effect of the silicon-bearing gases and hydrogen from the results of Example 1 and Example 2.

The system for controlling the average silicon particle size and PSD during the production of high-purity silicon, including the FBR, was assembled according to the systems in Example 1 and Example 2. The reference test was performed under the same temperature and pressure as in Example 1 and Example 2. Nitrogen was used as the only fluidizing gas injected with the first injection chamber and the second injection chamber.

The following parameters were adjusted to achieve the same fluid dynamic and mechanical conditions inside the fluidized bed as tested in Example 1 and Example 2. More specifically, the parameters using inert nitrogen as the fluidizing gas were adjusted in order to provide the silicon particles similar kinetic energy in the fluidized bed and to provide similar jet conditions in the distributor plate as were present in Example 1 and Example 2. The parameters include: (1) similar fluidization conditions as described in previous examples (nitrogen flow was adjusted to achieve the same degree of agitation inside the bed); (2) similar conditions in the gas jets exiting the orifices of the first and second injection chambers.

Two different criteria were followed and separately tested: (1) achieving the same gas exit velocity at the exit of the orifice of any of the injection chambers; and (2) achieving the same kinetic energy of the gases at the exit of the orifices.

To do this, the value ρ×U² was calculated for molar ratios of Examples 1 and 2 (ρ is the gas density at the exit of the orifices at given temperature and pressure and U the gas velocity value at the exit of the orifices), and the nitrogen gas injection conditions were adjusted accordingly.

With these assumptions, replicas of Examples 1 and 2 were conducted in inert conditions with nitrogen as the fluidizing gas.

### Example 3a

### Replica of Example 1

The reactor was filled with an initial charge of 120 kg silicon particles. The average silicon particle diameter size (dp50%) was 600 microns, with a maximum diameter (dp95%) of 1200 microns. The test was performed over a period of 24 hours. Sampling of the silicon particles was done every 4 hours. At the end of the test, the variation in PSD (generation of fines due to mechanical attrition) was approximately 3% or less.

### Example 3b

### Replica of Example 2

The reactor was initially filled with 120 kg of silicon particles prepared with a size distribution similar to that obtained from Example 1. The average silicon particle diameter size (dp50%) was 1650 microns, with a maximum diameter (dp95%) of 2200 microns. The test was performed over a period of 24 hours. Silicon particle sampling was done every 4 hours. At the end of the test, the variation in PSD (generation of fines due to mechanical attrition) was approximately 5% or less.

It will be obvious to those having skill in the art that many changes may be made to the details of the above-described embodiments without departing from the underlying principles of the invention. The scope of the present invention should, therefore, be determined only by the following claims.

1. A method of controlling the average silicon particle size during the production of high-purity silicon using a fluidized bed process, the method comprising:
providing a fluidized bed of silicon particles in a fluidized bed reactor, the fluidized bed reactor comprising a gas distribution plate having a first injection chamber and a second injection chamber configured to decrease or increase the average silicon particle size; and
increasing the average silicon particle size, wherein increasing the average silicon particle size comprises:
injecting a mixture of a fluidizing gas and a silicon-bearing gas from the first injection chamber into the fluidized bed of silicon particles, the mixture from the first injection chamber comprising 50 mol % or greater of a silicon trihalide; and
injecting a mixture of a fluidizing gas and a silicon-bearing gas from the second injection chamber into the fluidized bed of silicon particles, the mixture from the second injection chamber comprising a minimum purging gas flow sufficient to keep orifices of the second injection chamber free from silicon particles; or
decreasing the average silicon particle size, wherein decreasing the average silicon particle size comprises:
injecting a mixture of a fluidizing gas and a silicon-bearing gas from the first injection chamber into the fluidized bed of silicon particles, the mixture from the first injection chamber comprising a minimum purging gas flow sufficient to keep orifices of the first injection chamber free from silicon particles; and
injecting a mixture of a fluidizing gas and a silicon-bearing gas from the second injection chamber into the fluidized bed of silicon particles, the mixture from the second injection chamber comprising 60 mol % or greater of a silicon tetrahalide.

2. The method of claim 1, wherein increasing the average silicon particle size further comprises narrowing the particle size distribution.

3. The method of claim 1, wherein increasing the average silicon particle size comprises injecting a mixture of a fluidizing gas and a silicon-bearing gas from the first injection chamber into the fluidized bed of silicon particles, wherein the injected mixture exits the first injection chamber with a subsonic velocity of from 30 m/s to 55 m/s.

4. The method of claim 1, wherein increasing the average silicon particle size further comprises providing a gas flow from the first injection chamber to the fluidized bed of from 2×U_{mf} to 6×U_{mf}.

5. The method of claim 1, wherein increasing the average silicon particle size further comprises providing a ratio of the flow of silicon-bearing gas to the total surface area of the silicon particles in the fluidized bed reactor of from 0.15 (kg/h gas/m² silicon particles) to 0.75 (kg/h gas/m² silicon particles).

6. The method of claim 1, wherein increasing the average silicon particle size comprises injecting a mixture of a fluidizing gas and a silicon-bearing gas from the first injection chamber comprising from 10 to 25 mol % hydrogen, from 75 to 90 mol % of a silicon trihalide, and from 5 to 10 mol % of a silicon tetrachloride and injecting a mixture of a fluidizing gas and a silicon-bearing gas from the second injection chamber comprising a minimum purging gas flow of at least 10 mol % of a silicon tetrahalide diluted in hydrogen.

7. The method of claim 1, wherein decreasing the average silicon particle size further comprises widening the particle size distribution.

8. The method of claim 1, wherein decreasing the average silicon particle size further comprises grinding and attrition of the silicon particles and the production of small silicon particles and fines.

9. The method of claim 1, wherein decreasing the average silicon particle size comprises injecting a mixture of a fluidizing gas and a silicon-bearing gas from the second injection chamber into the fluidized bed of silicon particles, wherein the injected mixture exits the second injection chamber with a subsonic velocity of from 50 m/s to 75 m/s.

10. The method of claim 1, wherein decreasing the average silicon particle size further comprises providing a gas flow from the second injection chamber to the fluidized bed of from 4×U_{mf} to 8×U_{mf}.

11. The method of claim 1, wherein decreasing the average silicon particle size further comprises providing a ratio of the flow of silicon-bearing gas to the total surface area of the silicon particles in the fluidized bed reactor of from 0.05 (kg/h gas/m² silicon particles) to 0.25 (kg/h gas/m² silicon particles).

12. The method of claim 1, wherein decreasing the average silicon particle size comprises injecting a mixture of a fluidizing gas and a silicon-bearing gas from the first injection chamber comprising a minimum purging gas flow of at least 10 mol % of a silicon tetrahalide diluted in hydrogen; and injecting a mixture of a fluidizing gas and a silicon-bearing gas from the second injection chamber comprising from 10 to 25 mol % hydrogen, from 60 to 75 mol % silicon tetrahalide, and from 10 to 25 mol % silicon trihalide.

13. The method of claim 1, wherein controlling the average silicon particle size comprises alternating between increasing the average silicon particle size and decreasing the average silicon particle size in the fluidized bed reactor in order to maintain a continuous production of high-purity silicon.

14. The method of claim 1, further comprising sampling the silicon particles from the fluidized bed reactor in order to calculate the average particle size and the particle size distribution.

15. A fluidized bed reactor configured for controlling the average silicon particle size during the production of high-purity silicon, comprising:
a reaction chamber;
a first gas injection tube to deliver a first gas mixture having a molar ratio of silicon-bearing gas and fluidizing gas to increase the average silicon particle size;
a second gas injection tube to deliver a second gas mixture having a molar ratio of silicon-bearing gas and fluidizing gas to decrease the average silicon particle size; and
a gas distribution plate having a first injection chamber in fluid communication with the first gas injection tube, and a second injection chamber in fluid communication with the second gas injection tube, wherein the first injection chamber and the second injection chamber are configured to inject the first and second gas mixtures into the reaction chamber.

16. The fluidized bed reactor of claim 15, wherein the first injection chamber is not in fluid communication with the second injection chamber before entering the reaction chamber.

17. The fluidized bed reactor of claim 15, wherein the gas distribution plate has an inclination angle from approximately 65° to 75° from horizontal.

18. A system for controlling the average silicon particle size during the production of high-purity silicon using a fluidized bed process, the system comprising:
a fluidized bed reactor comprising a reaction chamber for holding fluidized silicon particles during the fluidized bed process;
a first gas injection supply in fluid communication with the fluidized bed reactor, the first gas injection supply providing a first gas mixture at a first velocity and a molar ratio of silicon-bearing gas and fluidizing gas configured to increase the average silicon particle size;
a second gas injection supply in fluid communication with the fluidized bed reactor, the second gas injection supply providing a second gas mixture at a second velocity and a molar ratio of silicon-bearing gas and fluidizing gas configured to decrease the average silicon particle size;
a gas injection zone located in the reaction chamber and having a gas distribution plate divided into a first injection chamber in fluid communication with the first gas injection supply, and a second injection chamber in fluid communication with the second gas injection supply;
a gas outlet for the exit of effluent gas from the reaction chamber; and
a silicon product removal outlet for removal of the high-purity silicon product and for sampling the silicon particles for determination of the average silicon particle size.

19. The system of claim 18, wherein the first gas injection supply comprises the first gas mixture having from 10 to 25 mol % hydrogen, from 75 to 90 mol % silicon trihalide, and from 5 to 10 mol % silicon tetrahalide.

20. The system of claim 18, wherein the second gas injection supply comprises the second gas mixture having from 10 to 25 mol % hydrogen, from 60 to 75 mol % silicon tetrahalide, and from 10 to 25 mol % silicon trihalide.

21. The system of claim 18, wherein the first gas injection supply comprises the first gas mixture having from 10 to 25 mol % hydrogen, from 75 to 90 mol % trichlorosilane, and from 5 to 10 mol % silicon tetrachloride.

22. The system of claim 18, wherein the second gas injection supply comprises the second gas mixture having from 10 to 25 mol % hydrogen, from 60 to 75 mol % silicon tetrachloride, and from 10 to 25 mol % trichlorosilane.
